(19) United States
(12) Patent Application Publication
(10) Pub. No.: US 2011/0102279 A1
(43) Pub. Date: May 5, 2011

(54) TRANSPONDER COMPRISING A BOOSTER ANTENNA

(75) Inventors: Mikko Immonen, Konigstein-Falkenstein (DE); Samuli Strömberg, Tampere (FI)

(73) Assignee: UPM Raflatac Oy, Tampere (FI)

(21) Appl. No.: 12/936,267

(22) PCT Filed: Mar. 25, 2009
(86) PCT No.: PCT/FI09/50223

§ 371 Date: Dec. 27, 2010

(30) Foreign Application Priority Data
Apr. 3, 2008 (FI) 20085281

(51) Int. Cl. H01Q 1/08; H01Q 1/00

(52) U.S. Cl. 343/720; 343/880

(57) ABSTRACT

A transponder including a first antenna and an integrated circuit on a chip electrically connected to the first antenna. A second antenna is physically separated from the first antenna. The second antenna is close enough to the first antenna so that the second antenna can couple with the first antenna. One of the first antenna and the second antenna is transferable with respect to the other antenna so that the coupling between the antennas is preventable.

The present invention relates to a transponder, comprising a first antenna and an integrated circuit on a chip electrically connected to the first antenna.

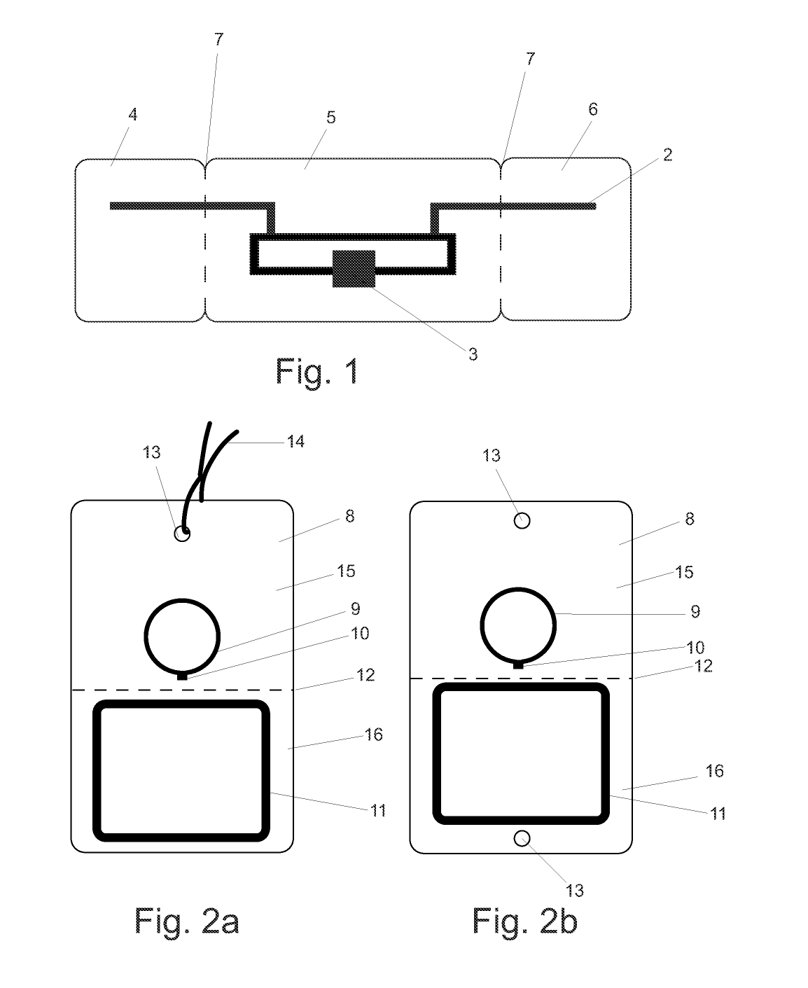

One known transponder whose operating, i.e. wireless communication range can be reduced is a tag comprising a substrate, an antenna and an integrated circuit on a chip attached to the antenna. The substrate of the tag comprises three parallel parts which are separated from each other by perforated lines. The antenna extends over all parts of the substrate. The chip is situated in the middle part and it is attached to the antenna. The other parts of the substrate can be removed from the middle part of the substrate by tearing them apart. Thus, the operating range of the tag is reduced because the antenna arrangement is altered. Such a transponder is shown in FIG. 1.

The transponder of the invention is characterized in that the transponder comprises a second antenna which is physically separated from the first antenna but it is in proximity to the first antenna so that the second antenna is capable of coupling with the first antenna, and one of the antennas is positionally transferable with respect to the other antenna so that the coupling between the antennas is preventable.

In the present invention, there is a transponder which comprises a separate second antenna, i.e. a booster antenna. The second antenna enhances the functioning of the first antenna, i.e. the second antenna lengthens the operating distance of the transponder or otherwise improves the radio communication to and/or from the transponder. The second antenna is physically separated from the first antenna and their mutual interaction is possible when they are sufficiently close to each other, i.e. the coupling of the antennas is possible. When the distance between the first antenna and the second antenna becomes longer it is not possible to boost the first antenna by the second antenna any longer. Therefore, the transponder of the invention opens up new ways to use transponders.

The tag comprising the first antenna and the integrated circuit on the chip or the second antenna may still be used because neither the tag nor the second antenna needs to be broken or removed in order to reduce the operating range, because the reduction of the operating range can be arranged simply by positioning those parts sufficiently far respect to each other.

The transponder of the invention is especially useful in connection with shoes, garments and related accessories, such as belts or bags.

According to the first embodiment of the invention, the transponder comprises a first antenna and an integrated circuit on a chip electrically connected to the first antenna on a substrate. A second antenna, which enhances the functioning of the first antenna, is physically separated from the first antenna but in proximity to the first antenna so that the second antenna is capable of coupling with the first antenna to boost the communication distance of the first antenna. Either one of the antennas is arranged to be positionally transferable with respect to the other antenna so that the coupling between the antennas can be intentionally prevented.

The second antenna may lie on the same substrate as the first antenna and the chip, but it may also lie on a separate substrate. The substrate may be a tag which is intended to be used as a hang tag, especially with garments, and it may be made of cardboard. The tag may be divided into at least two regions whose borderline may be perforated or otherwise marked in order to make it possible to tear those parts apart so that the long-range tag is in this way transformed into a proximity tag, i.e. the mutual coupling of the antennas is prevented.

The first antenna and the integrated circuit on the chip may be in the upper part of the tag, and the second antenna may be in the lower part of the tag so that it is easy to tear that part off the tag. After the second antenna has been removed from the hang tag, the first antenna and the integrated circuit on the chip attached to the first antenna work as a small distance transponder so that the small distance transponder can be used, for example, as a receipt which can be used e.g. in connection of product returns. In addition to the straight hang tag, the hang tag may be a folded tag so that the first antenna and the integrated circuit on the chip are on one side of the fold, and the second antenna is on another side of the fold.

It is also possible that the first antenna and the attached chip and the second antenna change places. The second antenna may be in the upper part of the tag, and the first antenna may be in the lower part of the tag so that it is easy to tear that part off the tag. After the first antenna and the integrated circuit on the chip have been removed from the hang tag, they work as a small distance transponder so that the small distance transponder can be used, for example, as a receipt which can be used e.g. in connection of product returns. In addition to the straight hang tag, the hang tag may be a folded tag so that the first antenna and the integrated circuit on the chip are on one side of the fold, and the second antenna is on another side of the fold.

The substrate may be, for example, made of paper, plastics or cardboard. The first antenna and the second antenna may be printed directly on the substrate, or they may be cut from a metallic foil. The first and the second antenna may also be formed on a separate substrate, for example a polyester or polyolefin substrate, which is adhesively attached to the original substrate. In that case the manufacturing techniques of the antennas include printing, etching, cutting from a metallic foil, plating and any other additive techniques. For example, the antennas may be printed by using an electrically conductive paste, such as a conductive polymeric paste or a metallic paste, e.g. a silver paste. The printing method may be a screen printing method.

According to the second embodiment of the invention, the transponder comprises a first antenna and an integrated circuit on a chip electrically connected to the first antenna on a suitable substrate. A second antenna, which enhances the functioning of the first antenna, is physically separated from the first antenna. However, the second antenna is in proximity to the first antenna so that the second antenna is capable of coupling with the first antenna. Either of the antennas is positionally transferable with respect to the other antenna so that the coupling between the antennas can be prevented. For example, the first antenna and the chip may be attached to a hang tag. The second antenna may be situated inside an EAS device, preferably an EAS hard tag, and the first antenna and the chip may be situated at a suitable distance from the EAS device so that the second antenna enhances the functioning of the first antenna. It is also possible that the second antenna lies on the outer surface of the EAS device. A special advantage of this embodiment is that the EAS device can be re-used but that part which includes all the information stored in the chip can be removed, and the second antenna may be used again with another first antenna and chip.

Besides the EAS devices which work in radio frequencies the technique of the EAS device may be any other suitable EAS technique, such as magnetic, acousto-magnetic, or a technique based on microwaves.

The manufacturing techniques of the first antenna include printing, etching, cutting from a metallic foil, plating and any other additive techniques. For example, the first antenna may be printed by using an electrically conductive paste, such as a conductive polymeric paste or a metallic paste, e.g. a silver paste. The printing method may be a screen printing method.

The manufacturing techniques of the second antenna may include the same techniques as those of the first antenna. Also wire antennas may be considered. An antenna which has been formed on a substrate may be attached adhesively to the EAS device, or it may be molded inside a plastic material. It is also possible that the antenna is printed directly on a plastic material.

According to the third embodiment of the invention, the transponder comprises a first antenna and an integrated circuit on a chip electrically connected to the first antenna on a suitable substrate. A second antenna, which enhances the functioning of the first antenna, is physically separated from the first antenna. However, the second antenna is in proximity to the first antenna so that the second antenna is capable of coupling with the first antenna. Either one of the antennas is positionally transferable with respect to the other antenna so that the coupling between the antennas can be prevented. The tag comprising the first antenna and the integrated circuit on the chip is placed inside a watertight shell which also resists washing chemicals and mechanical impacts. The second antenna may be integrated in a garment. For example, the second antenna may be a woven pattern in a garment, or the second antenna may be printed on a textile or film material. This solution is especially useful in garments which are frequently washed in industrial laundries. The watertight shell may be formed by laminating material layers together, or it may be formed e.g. inside a button.

The first antenna may be manufactured by any suitable technique. The antenna may be formed, for example, of an electrically conductive fiber or it can be etched or printed. The antenna may contain copper, aluminium, or silver.

The watertight shell may be formed by laminating material layers together so that the first antenna is formed and the integrated circuit on the chip is attached to a mechanically and chemically durable substrate, such as a polyurethane or polyurethane-based film, and the substrate is hermetically sealed between two mechanically and chemically durable films, such as silicone polymer films or thermoplastic elastomer films.

When a watertight shell is formed inside a button, it is usually a molded structure whose material may be an epoxy or another suitable plastic.

The second antenna may be formed by integrating the antenna in a garment (e.g. using threads of the garment as the antenna), printing or etching. For example, the second antenna may be integrated in a collar, a sleeve, or a cloth badge attached to a garment.

According to the fourth embodiment of the invention, the transponder comprises a first antenna and an integrated circuit on a chip electrically connected to the first antenna on a suitable substrate. A second antenna, which enhances the functioning of the first antenna, is physically separated from the first antenna. However, the second antenna is in proximity to the first antenna so that the second antenna is capable of coupling with the first antenna. Either of the antennas is positionally transferable with respect to the other antenna so that the coupling between the antennas can be prevented. The second antenna may be integrated in a garment or a fibrous or a film product. For example, the second antenna may be a woven pattern in a garment, or the second antenna may be printed on a textile or film material. This kind of solution is useful, for example, in competition numbers or in sports jackets, such as downhill skiing jackets. Another option is that the first antenna and the integrated circuit on the chip are integrated or attached to a garment, and the first antenna is on a separate substrate, such as a hang tag.

A substrate of a competition number, such as a cloth or a nonwoven, may comprise a quite large second antenna, and a substantially small tag comprising a first antenna and an integrated circuit on a chip may be attached to the competition number. The small tag may be placed in a pocket in the competition number, or the small tag can be attached adhesively to the surface of the competition number. Such a competition number may be used, for instance, in marathon competitions or other running races. The coupling between the antennas is simply prevented by removing the tag from the range of the second antenna.

In sports jackets, the second antenna may be formed on the inner surface of a pocket which may be situated in a sleeve. A lift ticket comprising a first antenna and an integrated circuit on a chip may be placed in the pocket. The reading distance of the lift ticket will be remarkably enhanced, and therefore, a slalom skier can pass a gate more quickly.

In the following, the invention will be explained by drawings in which

FIG. 1 shows a tag of prior art from above,

FIGS. 2a and 2b show a tag according to the invention from above,

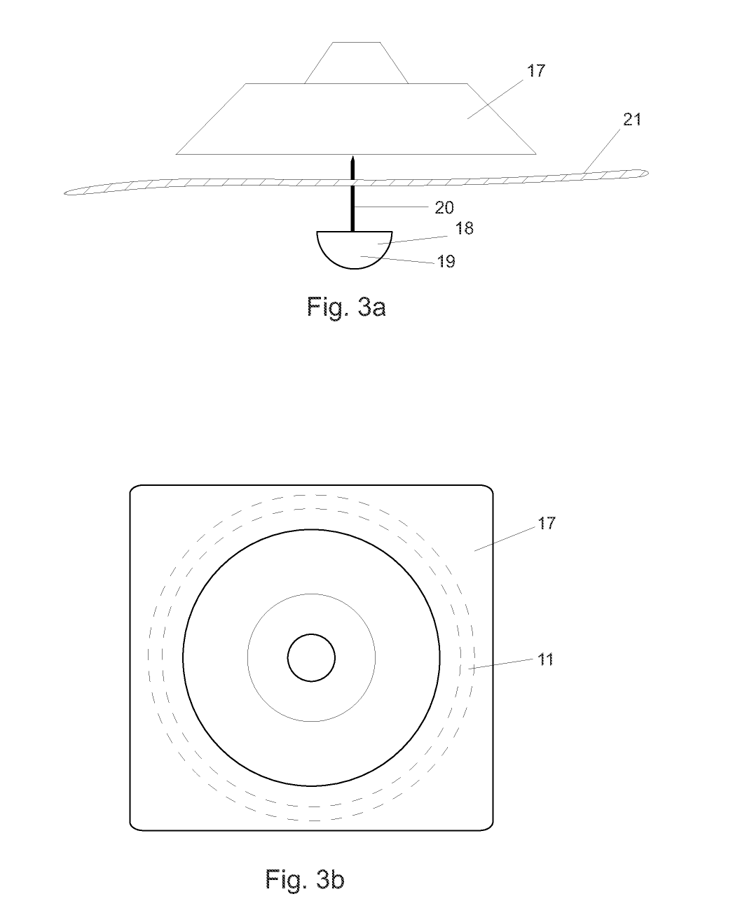

FIG. 3a shows a side view of an EAS hard tag,

FIG. 3b shows an EAS hard tag from above,

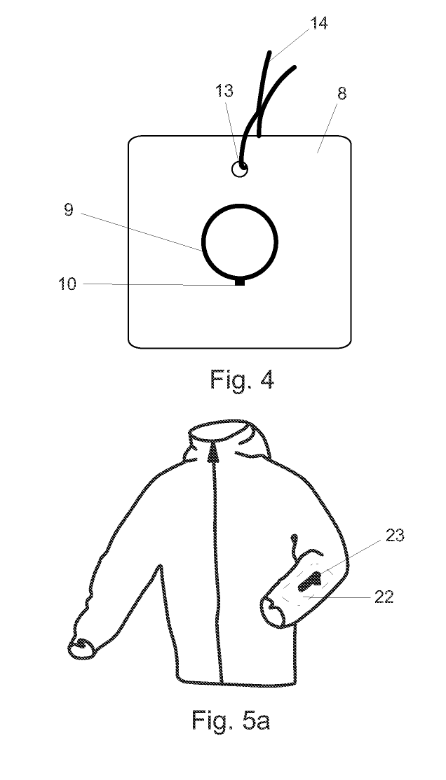

FIG. 4 shows a transponder tag from above,

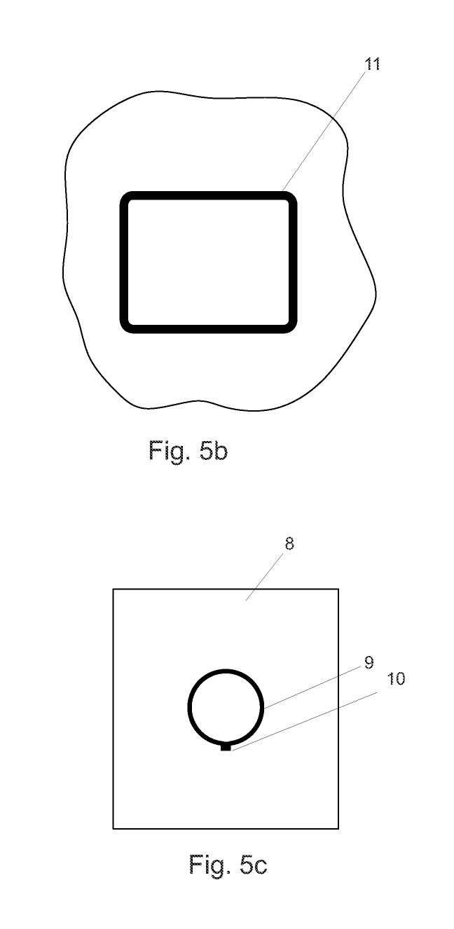

FIG. 5a shows a sports jacket comprising a pocket in a sleeve,

FIG. 5b shows the inner side of the pocket of FIG. 5a,

FIG. 5c shows the transponder tag to be inserted in the pocket of FIG. 5a from above, and

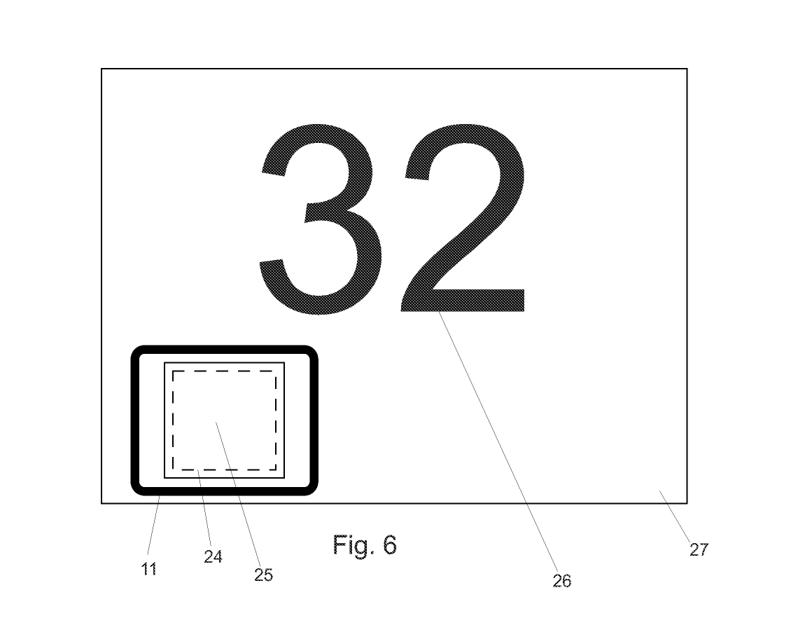

FIG. 6 shows a competition number from above.

FIG. 1 shows a tag according to the prior art. The tag comprises a substrate 1, an antenna 2 and an integrated circuit on a chip 3 attached to the antenna 2. The tag comprises three parts 4, 5 and 6. The parallel parts 4 and 5, and 5 and 6, are separated from each other by perforated lines 7. A consumer or a retailer may remove parts 4 and 6 by tearing them apart, and in this case part of the antenna 2 is removed together with the removed part 4 and/or 6. It should be noted that in such a prior art tag the removed parts of the antenna 2 are removed by cutting out the galvanic electrical connection between the antenna parts.

FIG. 2a shows a tag according to the invention. The tag comprises a substrate 8 which is separated in at least two parts 15 and 16 by a perforated line 12. The tag may also comprise a hole 13 through which, for example, a string 14 may be threaded for hanging the tag.

The first part 15 of the tag comprises a first antenna 9 and an integrated circuit on a chip 10 attached to the first antenna 9. The second part 16 of the antenna comprises a second antenna 11 which enhances the functioning of the first antenna 9, i.e. the second antenna 11 extends the reading range of the tag. The first and second antenna have no galvanic electrical connection arranged in between, but the connection between them is based on capacitive and/or inductive coupling. The first part 15 of the tag may be removed after purchasing, and after purchasing the first part 15 of the tag may be used as a receipt including all the information of the purchased product.

It is also possible to make a folded tag, as shown in FIG. 2b. The tag is folded along the line 12. The tag comprises two holes 13 through which, for example, a string 14 may be threaded for hanging the tag.

FIG. 3a shows a side view of an EAS hard tag. The EAS hard tag comprises a housing 17 and a detachable portion 18. The housing 17 contains the EAS unit. The EAS unit may be such that it is tuned to a predetermined frequency, e.g. 8.2 MHz. The detachable portion 18 comprises a head 19 and a pin 20.

The pin 20 is inserted through the substrate 21 to which the EAS hard tag is attached to a passageway (not shown) in the housing 17. The passageway comprises a locking mechanism (not shown) which locks the detachable portion 18 in its place. The detachable portion 18 is unlocked in connection with the purchase at a checkout.

FIG. 3b shows an EAS hard tag from above. The housing 17 contains besides the EAS unit a second antenna 11. The second antenna 11 may be inside the housing 17 as shown in FIG. 4a but it is also possible that the second antenna 11 lies on the surface of the housing 17.

FIG. 4 shows a transponder tag to be used with the EAS hard tag of FIG. 3b. The transponder tag comprises a substrate 8, an antenna 9 and an integrated circuit on a chip 10 attached to the antenna 9. The tag may also comprise a hole 13 through which, for example, a string 14 for hanging the tag may be threaded. The transponder tag is placed in a near proximity of the EAS hard tag so that the second antenna 11 is capable of enhancing the functioning of the first antenna 9.

FIG. 5a shows a sports jacket which includes a pocket 22 in a sleeve. The pocket 22 is closed with a zipper 23.

FIG. 5b shows the inner surface of the pocket 22 which comprises a second antenna 11. The second antenna may be printed on a plastic film which covers the inner surface of the pocket 22.

FIG. 5c shows a transponder tag to be used with the second antenna 11 of FIG. 5b. The transponder tag comprises a substrate 8, an antenna 9 and an integrated circuit on a chip 10 attached to the antenna 9. The transponder tag is placed in the pocket 22 so that the first antenna 9 and the second antenna 11 are in the close proximity so that the second antenna 11 can enhance the functioning of the first antenna 9.

FIG. 6 shows a competition number which comprises a visible competition number 26, a substrate 27, a second antenna 11, a pocket 24 and a transponder tag 25 inside the pocket 24. The transponder tag 25 may be similar to the transponder tag of FIG. 5c.

1-7. (canceled)

8. A transponder, comprising:
a first antenna;
an integrated circuit on a chip electrically connected to the first antenna; and
a second antenna that is physically separated from the first antenna, the second antenna being in proximity to the first antenna such that the second antenna can couple with the first antenna to boost a communication distance of the first antenna, and one of the first antenna and the second antenna is arranged to be transferable with respect to the another of the first antenna and the second antenna such that coupling between the first antenna and the second antenna can be intentionally prevented.

9. The transponder according to claim 8, further comprising:
a substrate having a surface on which the first antenna, the integrated circuit on the chip and the second antenna are situated, wherein the first antenna and the second antenna are separated from each other by a borderline.

10. The transponder according to claim 7, wherein the borderline comprises a perforation.

11. The transponder according to claim 8, wherein the first antenna and the integrated circuit on the chip are situated on a surface of a substrate, and wherein the second antenna is situated inside or on an outer surface of a housing of an EAS unit.

12. The transponder according to claim 8, wherein the first antenna and the integrated circuit on the chip are situated inside a watertight shell, and wherein the second antenna is integrated in a garment.

13. The transponder according to claim 8, wherein the first antenna and the integrated circuit on the chip are situated on a surface of a substrate, and wherein the second antenna is integrated in a textile or film material.

14. The transponder according to claim 8, wherein the first antenna and the integrated circuit on the chip are integrated in a textile or film material, and wherein the second antenna is situated on a surface of a substrate.
